(19) United States
(12) Patent Application Publication
(10) Pub. No.: US 2008/0320377 A1
(43) Pub. Date: Dec. 25, 2008

(54) DOCUMENT MANAGEMENT SYSTEM

(75) Inventors: Devasenapathi Periagraharam Seetharamakrishnan, Medford, MA (US); John Watlington, Acton, MA (US)

Correspondence Address: THORNE & HALAJIAN;APPLIED TECHNOLOGY CENTER, 111 WEST MAIN STREET, BAY SHORE, NY, 11706, US

(73) Assignee: FRANCE TELECOM, Paris (FR)

(21) Appl. No.: 11/768,146

(22) Filed: Jun. 25, 2007

(51) Int. Cl. G06F 15/00; G06F 17/00

(52) U.S. Cl. 715/200; 345/418

(57) ABSTRACT

A document management system including a repository for storing electronic documents, a portable display for displaying an electronic document stored in the portable display, a folder adapted to physically receive the portable display. The repository may include a digital representation of the folder. The system may link in the repository the electronic document with the digital representation when the portable display is received in the folder. The system takes advantage of the physicality of the folder and the display with an added indexing, i.e. filing, resulting from the insertion. The portable display may be an electronic-paper display. The repository may be arranged to store the at least one electronic document in the digital representation when the portable display is received in the folder. The electronic document may be sent to the repository for storage in association with the digital representation of the folder.

### FIELD OF THE PRESENT SYSTEM

This present system relates to document management systems in general, and more specifically to a document management system to organize and retrieve documents from an electronic document database.

### BACKGROUND OF THE PRESENT SYSTEM

Digital document technologies offer many benefits. Among other things, a large number of digital documents can be easily stored in small physical space. For instance, a single DVD disk, that is a few inches in diameter and few millimeters in thickness, can store several gigabytes of data. Furthermore, the stored digital documents are easy to manipulate: searching, sorting, viewing and editing information in digital documents is most of the time straightforward, even if these documents are several hundred pages long. Additionally, digital documents can be easily shared and transferred to other parties even if they are located in a different part of the world, using one of the many convenient Internet applications such as electronic mail.

In spite of these benefits of digital document technologies, paper continues to dominate office and business environments, defeating repeated attempts to create paperless office environments. Office workers are not willing to let go of the paper due to certain conveniences offered by paper, as explained by Sellen and Harper in “The Myth of the Paperless Office” published by the MIT Press. Among the conveniences, the authors state that since paper is tangible, readers can be literally hands-on as they move through a text, skimming text, flicking through pages, and feeling where they are all at the same time. In essence, paper offers quick, flexible navigation through and around documents. Furthermore, as paper is inexpensive, light and mobile, readers can spread documents in space in such a way that they can read across an arrangement of documents or pages. They can place them side-by-side, stack them in piles, pull them in and out of the center of the workspace, and glance quickly from one to another. Such flexible arrangements allow readers to read multiple documents at the same time and to place the documents according to their interrelationships. For example, all the documents of a specific project can be placed in the same pile.

Moreover, since paper is readable and writeable, readers can take notes while reading a document. Additionally, paper is very convenient to handle, therefore, multiple paper documents can be used at the same time. For instance, while reading a document, a reader can take notes on another sheet of paper.

Although paper documents have these attractive properties, it is desirable to reduce paper usage, as the costs of delivering, distributing, processing, storing, archiving and destroying paper are high. Moreover, conventional paper documents cannot be easily searched, indexed, linked or retrieved.

Many known systems have tried to answer these limitations by proposing digital document management systems. For example, U.S. Pat. No. 7,086,000, titled “Tagging related files in a document management system” discloses a tagging mechanism for retrieving related documents in a computer file system. U.S. Pat. No. 7,111,024, titled “Document management system for automating operations performed on documents in data storage areas”, presents a mechanism for performing file management operations on a set of digital documents simultaneously. U.S. Pat. No. 6,829,601, titled “Document Management System” discloses a system for applying relationships or links between documents.

If these systems present solutions to facilitate the searching or indexing of digital documents, they all fail to propose a solution that would come any closer to offering some, if not all, of the conveniences of paper as listed before.

Today there is a need for a digital document management system offers the tangibility and flexibility of traditional paper while retaining the storage and management efficiencies enabled by the digital technologies. Users could embrace such a system as it combines the benefits of both worlds.

### SUMMARY OF THE PRESENT SYSTEM

It is an object of the present system to recite a system and a method to overcome disadvantages and/or make improvements in the prior art.

It is a further object of the present system to present a document management system that can be as convenient as the known paper based system, with additional searching, indexing and linking capabilities of digital documents.

Accordingly, the present system relates to a document management system comprising:
a repository for storing electronic documents,
a portable display for displaying at least one electronic document stored in said portable display,
a folder adapted to receive the portable display,

wherein the repository comprises a digital representation of the folder, said system being arranged to link in said repository the at least one electronic document with said digital representation when the portable display is received in said folder.

A novel system that combines the advantages of paper and digital technologies is presented. The system is particularly well suited for networked electronic displays. The system takes advantage of the physicality of the folder and the display. The insertion of the portable display in the portable folder is similar to what a user would do with a paper document in a folder, with an added indexing, i.e. filing, resulting from the insertion.

In an accordance with an additional embodiment of the present system, the portable display is an electronic-paper display. Such portable displays have the “feel” of paper because they reflect light like ordinary paper (unlike a conventional flat panel displays that use a backlight to illuminate their pixels) and are capable of holding text and images indefinitely without consuming electricity or processor power. These displays can function like conventional electronic displays since their contents can be electrically changed.

In accordance with an additional embodiment of the present system, the repository is arranged to store the at least one electronic document in the digital representation when the portable display is received in the folder.

In accordance with a further embodiment of the present system, the electronic document is sent to the repository for storage in association with the digital representation of the folder.

The present system also relates to a portable display for displaying at least one electronic document stored in said portable display, said portable display being operatively coupled to a document management server, and comprising:
a sensing element for detecting the insertion of the portable display in a folder adapted to receive said portable display,
a communication interface for sending insertion information to the document management server once the insertion is detected by the sensing element.

The present system also relates to a method and an application embodied on a computer readable medium for indexing the data files carried by a portable display.

In another aspect of the present system, the present system recites a document management system comprising:
a first portable display for displaying at least one electronic document,
a second portable display adapted to display the at least one electronic document,
   wherein the first portable display comprises a sensing element to detect the second portable display when placed in the vicinity of said first portable display, said detection causing the transfer of the at least one electronic document from said first to said second portable display for a subsequent display on said second portable display.

Thanks to these features, an easy sharing of the data files is achieved from one portable display to another neighboring one.

### BRIEF DESCRIPTION OF THE DRAWINGS

The present device is explained in further detail, and by way of example, with reference to the accompanying drawings wherein:

FIG. 1 illustrates one embodiment of the document management system according to the present system;

FIG. 2 illustrates an exemplary embodiment of a portable display used in the system according to the present system;

FIG. 3 illustrates an exemplary embodiment of a portable folder used in the system according to the present system;

FIG. 4 illustrates an exemplary embodiment of a scanner used in the system according to the present system;

FIG. 5 illustrates an exemplary embodiment of a printer used in the system according to the present system;

FIG. 6 illustrates an exemplary embodiment of a recycle bin used in the system according to the present system;

FIG. 7 illustrates an exemplary embodiment of a shredder used in the system according to the present system;

FIG. 8 shows a flow chart describing a method for finding free space on the storage of the system according to the present system;

FIG. 9 shows a flow chart describing a method for finding content on the storage of the system according to the present system;

FIG. 10 shows a flow chart describing a method for naming a portable folder in the system according to the present system:

FIG. 11 shows a flow chart describing a method for converting paper documents for a subsequent display on the portable display of the system according to the present system;

FIG. 12 shows a flow chart illustrating a method to convert the portable display content to conventional paper form in the system according to the present system;

FIG. 13 shows a flow chart illustrating a method to recycle a portable display in the system according to the present system;

FIG. 14 shows a flow chart illustrating a method to “shred” the contents of a portable display in the system according to the present system;

FIG. 15 shows a flow chart illustrating a method to share content among neighboring portable displays in the system according to the present system; and,

FIG. 16 shows a flow chart illustrating a method to store the contents of a portable display in a portable folder in the system according to the present system.

### DETAILED DESCRIPTION OF THE PRESENT SYSTEM

The following are descriptions of illustrative embodiments that when taken in conjunction with the following drawings will demonstrate the above noted features and advantages, as well as further ones. In the following description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well-known devices, circuits, modeling tools, analysis techniques and methods are omitted so as not to obscure the description of the present system. It should be expressly understood that the drawings are included for illustrative purposes and do not represent the scope of the present system.

The system according to the present system combines the benefits of conventional paper and digital documents into a hybrid document management system that is convenient and natural to use.

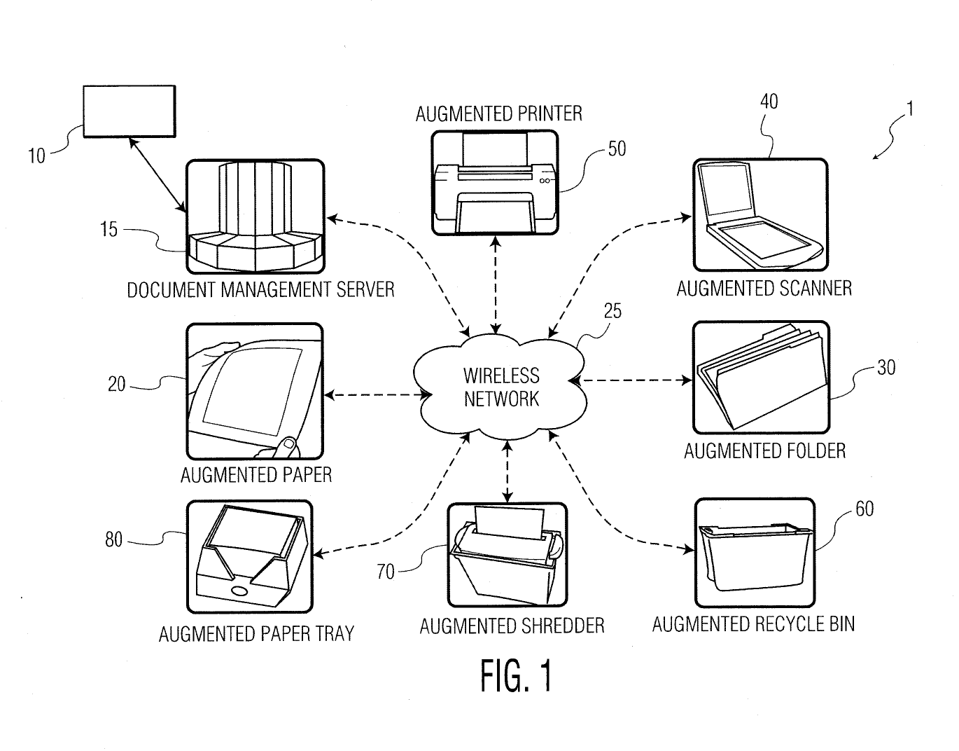

An exemplary embodiment of the proposed system 1 is depicted in FIG. 1. The document management system 1 according to the present system comprises:
a repository 10 for storing electronic documents, also called here after data files,
a portable display 20 for displaying at least one data file stored on said portable display, and,
a folder 30 adapted to receive the portable display. The folder will be illustrated here after as, but not limited to, a portable folder. Folders may also be static, e.g. located in cabinets for storing the portable displays in a dedicated storage place.

In the system according to the present system, the repository 10 comprises a folder representation (not shown in FIG. 1), i.e. a digital representation of the portable folder 30, said repository being arranged to store the at least one data file in said folder representation when the portable display 20 is received in said portable folder 30.

A document management server (DMS) 15 may be used to host a software component that coordinates all the components of the system according to the present system and provides a convenient content management interface. Server 15 may be an interface between a plurality of portable displays 20, portable folders 30 and repository 10. Server 15 may handle for instance the transfer of data files back and forth between a portable display 20 and repository 10. Server 15 may also handle the transfer of the data files into the folder representation of portable folder 30 when a portable display 20 is inserted into said portable folder 30.

Repository 10 is one (or more) storage medium wherein a plurality of data files is stored. Repository 10 is used as a back up storage for all documents handles by the document management system according to the present system. A person skilled in the art will also understand that repository 10 may also comprise multiple distributed storage media, accessible either directly of through a network.

Data files may correspond to any digital file that can be viewed using the portable displays, e.g. text documents, slide presentations, tables, or the likes. Data files in repository 10 may also have been created from scanning conventional paper documents. Unless mentioned otherwise, electronic data files or electronic documents available for display in portable display 20 will also be referred to electronic content, or content in short. The data files on repository 10 will also be referred to as electronic copies of the portable display content.

A wireless network 25 is provided to ensure that the different components of the system according to the present system communicate with each other. The network can be based on any wireless networking technology such as IEEE 802.11 (like WIFI), UWB (Ultra Wide Band), Blue Tooth, Infra Red and the likes. A described here after, the different components such as the portable display 20, the portable folder 30 and the server 15 may be equipped with the necessary components (antenna, transmitter, receiver etc) to communicate over the wireless network 25 with each other. These devices, as illustrated in FIG. 1, can also communicate with additional system components such as digital cameras, scanners, etc.

The system components may use one type of wireless technology to communicate directly with each others, and another type of wireless technology to communicate indirectly through the document management server, which may then for example keep a log of the communication. Unless mentioned otherwise in the hereafter description, both types of communications fall within the scope of the present system.

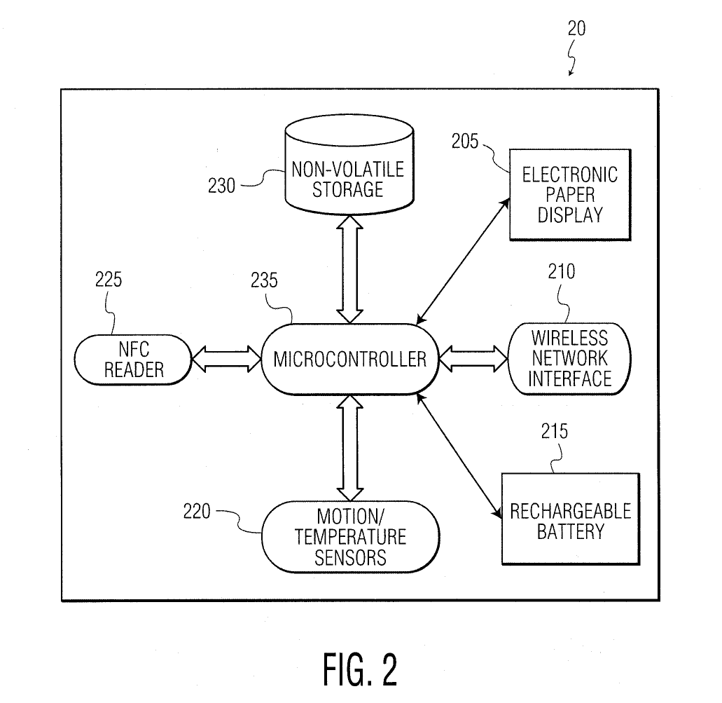

An exemplary embodiment of a portable display 20 is shown in FIG. 2. The portable display is the element in the system according to the present system used to present (for writing and reading) an electronic document. In accordance with an additional embodiment of the present system, the portable display 20 is an electronic paper. Such portable displays have the “feel” of paper because they reflect light like ordinary paper (unlike conventional flat panel displays that use a backlight to illuminate their pixels) and are capable of holding text and images indefinitely without consuming electricity or processor power. These displays can function like other known electronic display technologies since their contents can be electronically changed.

Another important benefit of electronic paper is that it is easy to read at angles much wider than the ones supported by other electronic displays. It is also lighter, stronger and more flexible than the other electronic display devices. The electronic paper will also be referred to here after as an Augmented Paper or AP. The different features of the portable display 20 described with respect to electronic paper displays are only illustrations. A person skilled in the art may easily adapt these features to an ordinary portable display unit, such as, but not limited to, a PDA or a mobile phone, or a portable computer.

As shown in FIG. 2, the augmented paper 20 is an electronic paper and may be enhanced with one of more of the following elements. AP 20 is provided with a screen 205 to present to the user a data file corresponding to a document. The screen 205 may be enhanced with a touch screen interface for an easier handling of documents. AP 20 also comprises a microcontroller 235 as the main computational unit of the AP, the microcontroller managing the different elements of the AP, such as the screen 205. A microprocessor may also be used instead of the microcontroller. In this document, the terms “microprocessor” and “microcontroller” are used interchangeably to describe a Central Processing Unit (CPU).

AP 20 further comprises a contactless reader 225 adapted to read identification tags such as RFID (Radio Frequency Identification) or NFC (Near Field Communication) tags. Additionally, the contact-less reader 225 may emulate an identification tag. For instance, the contactless reader 225 may behave like an identification tag (for storing an AP identifier) when another contactless reader wants to communicate with it. This characteristic allows an AP to identify a neighboring AP or any other devices of FIG. 1.

AP 20 further comprises a wireless transceiver 210, i.e. a wireless network interface, used for establishing communication (sending and receiving data) between two augmented papers, or between an AP and other devices of the document management system according to the present system as shown in FIG. 1. Data transfer may transit through document management server 15 using the wireless network 25. Alternatively, data transfer may be a direct transfer from one component of the system to the other using a local transfer through technologies such as Near Field Communications (NFC). The transferred data could be data files or control information such as authentication credentials or meta information about files such as file size, last modified date, etc.

AP 20 may also be equipped with different sensors 220 to determine various usage and environmental conditions. For instance, capacitive sensor affixed on the edges of the paper can be used to determine the way the user is holding the paper and change the orientation (landscape/portrait) accordingly. A motion sensor may be used to determine whether a user is currently holding the AP, if so, wakeup the AP automatically, if it was in sleep mode. Sleep mode is used to minimize power consumption by automatically turning off the AP whenever it is not in use.

AP 20 may also comprise a non-volatile storage 230. The AP may support two types of non-volatile storage:
1. a fixed non-volatile storage such as a flash memory or EEPROM, used to store system-level information such as passwords and cryptographic keys, and the different electronic documents of the augmented paper,
2. a removable non-volatile storage such as Compact Flash (CF) card or Multi Media card (MMC) may be used to increase the storage capacity.

AP may also be equipped with rechargeable batteries 215 such as lithium-polymer batteries to provide a light-weight portable source of power.

An Augmented Paper 20 may be further equipped with a soft keypad (not shown in FIG. 2). In addition to the usual alphanumeric, punctuation and function keys, the following special keys may be present on this keypad:
1. Page Up and Page Down—These keys may be used to browse through an AP electronic document,
2. Browse—to view the different electronic documents stored on AP 20, as the AP content may comprises several different documents,
3. Zoom In/Zoom Out—These keys may be used to increase/decrease the size of text or image from the document currently displayed,
4. System Lock—which locks the contents of the AP so that the contents cannot be accessed without required login credentials,
5. Power—to turn ON/OFF the augmented paper 20,
6. Recycle—to empty the contents of the augmented paper 20. (The same functionality may also be achieved, as described below, by placing the AP in the recycle bin 35 (as seen in FIG. 1) of the system according to the present system),
7. Shred—to delete the contents of the AP 20 and any copies of those contents on the storage repository. (The same functionality may also be achieved, as described below, by placing the AP 20 in a shredder 40 of the system according to the present system),
8. Network Sync—to start a synchronization process with the storage repository,
9. Save—the contents are stored on AP.
10. Save As—The contents can be saved under a different name by pressing this key and specifying an appropriate name.

A person skilled in the art will understand that this list is not exhaustive or comprehensive. Keys can be added or removed as needed by the system according to the present system.

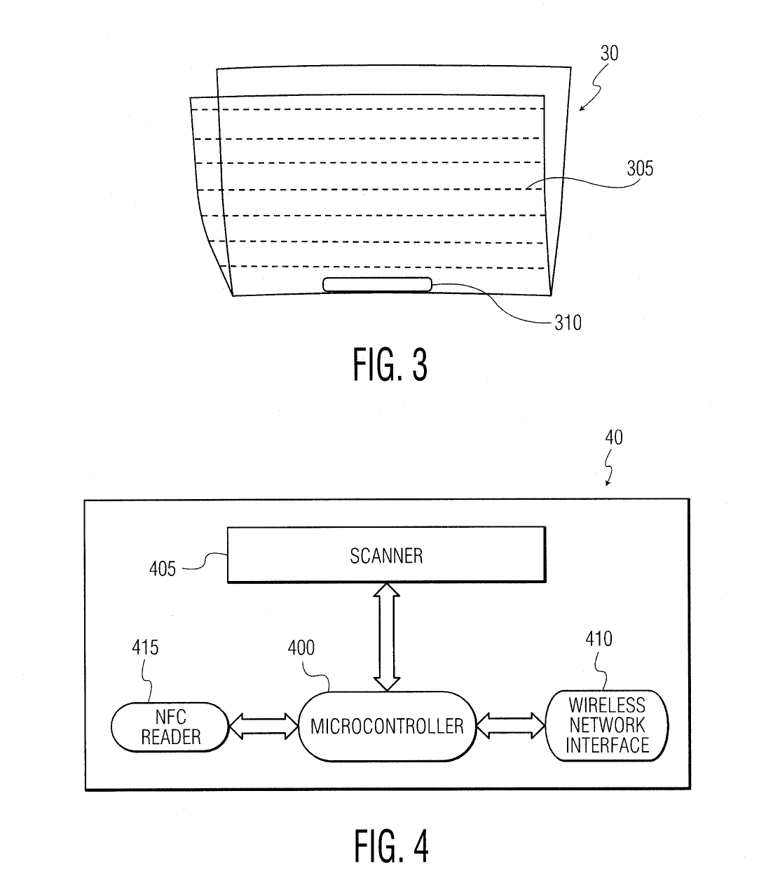

As shown in FIG. 3, a portable folder 30, also called herein an augmented folder, or AF, may be an ordinary folder 305 equipped with an identification tag 310, placed for example at the spine of the folder. The identification tag is used to uniquely identify the portable folder 30 through storing e.g. an identifier, also called an AF ID. Tag 310 may be an RFID, an NFC tag, or the likes. In an additional embodiment of the system according to the present system, AF 30 may incorporate a Radio Frequency (RF) shielding structure such as an aluminum foil used to prevent RF waves inside the folder leaking through and interfering with other portable folders in the vicinity. In other words, this shield prevents any interference in communication.

In an alternative embodiment of the system according to the present system, AF 30 could be equipped with a contactless reader. If such a reader is provided, it could be used to establish a nested folder structure as described below.

In accordance with an additional embodiment of the present system, the readers and tags of AP 20 and AF 30 can also be active communication devices with built-in sources of power. For example, an active RFID device could be used for this purpose.

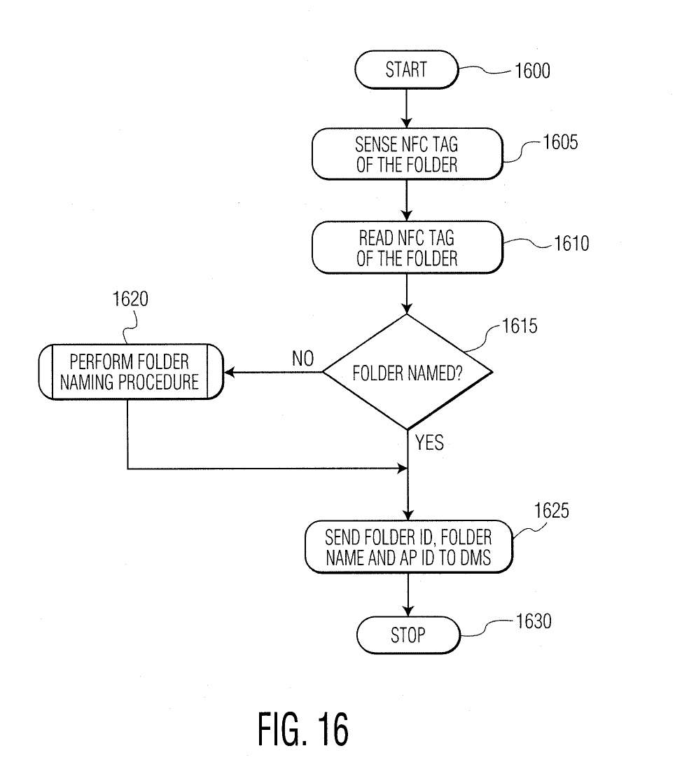

In the system according to the present system, AP 20 is adapted to communicate with server 15 so that when said AP 20 is inserted into an augmented folder 30, server 15 receives the information that the data file in AP 20 is to be associated with a digital representation for folder 30 in repository 10. In an alternative embodiment of the system according to the present system, AF 30 is adapted to perform the communication. Whether the information originates from AP 20 or AF 30, the physical insertion, as described later on, of AP 20 into folder 30 will cause server 15 to link or associate the data file to the digital representation of folder 30 in repository 10. If data file does not exist yet in repository 10, the file may be also transferred to repository 10. If folder 30 has not been identified yet, an identification procedure may be executed first as will be seen later on in relation to FIG. 16.

Additional components, as seen in FIG. 1, may be provided in the system according to the present system. Examples are listed in relation to FIG. 4 to 7. Other examples are within the scope of this present system.

A scanner 40, also called herein augmented scanner (AS), may be provided to scan conventional paper documents and transmit the information over a wireless network 25 to an AP 20 in its output tray. This forms a convenient tool for converting existing paper documents to “digital” data files that can be viewed with an AP 20. A block diagram of the augmented scanner 40 is presented in FIG. 4. AS 40 comprises a microcontroller 400 that manages the different components of the AS, such as, but not limited to:
a conventional scanner 405 to scan paper documents and convert them into digital data files,
a contactless reader 415 to recognize the AP (i.e. read the AP identification tag) that has been placed inside the AS 40 (if the AS is adapted to physically receive an AP) or next to it (within the communication range of reader 415). NFC technology may be used to that matter, and,
a wireless network interface 410 to transfer the digital data file corresponding to the scanned document from AS 40 to AP 20 via network 25. The transfer is triggered once the AP has been identified by AS 40 and the paper document is scanned. As seen before in relation to AP to AP transfer, the transfer from AS 40 to AP 20 may be a direct local transfer (Blue Tooth, Infra Red and the likes) or indirect through server 15 (using wireless only, or a local area network between AS 40 and server 15, and wireless between server 15 and AP 20). These exemplary communication protocols are also valid for the additional devices detailed here after.

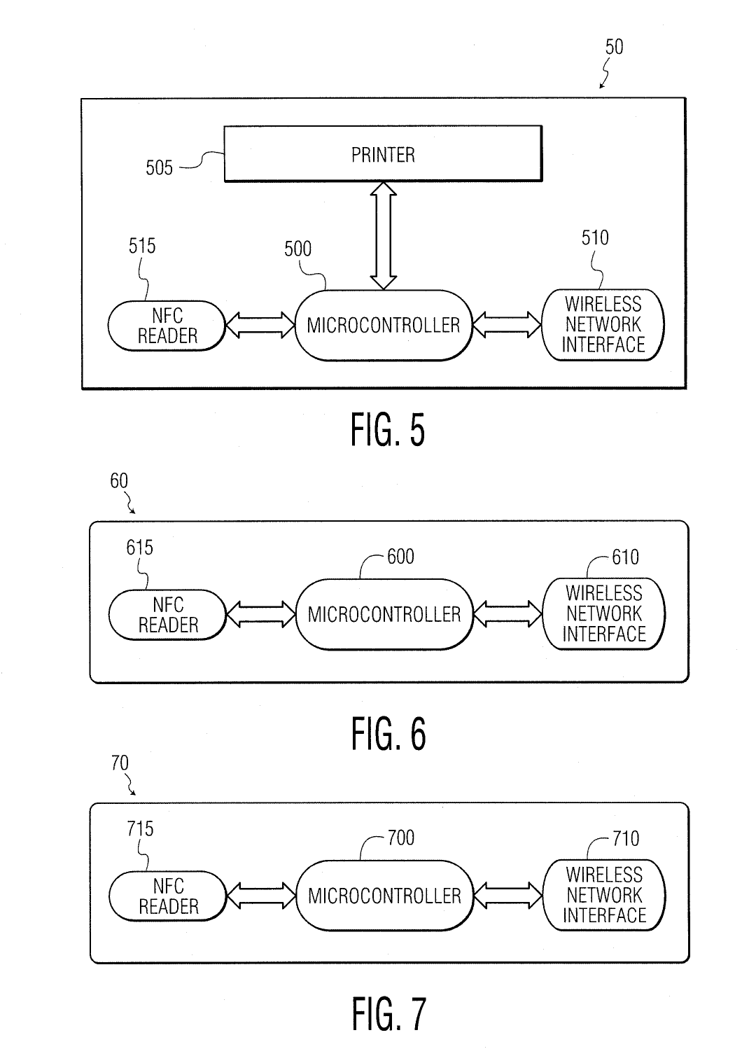

A printer 50, also referred to here after as Augmented Printer (APR), may also be provided in the system according to the present system as seen on FIG. 1. Augmented printer 50 performs the inverse functionality of the above-described AS 40: it downloads the content of an AP and prints it to conventional paper sheets. This APR 50 can also be further enhanced to provide other functionality such as email and fax services. For instance, the APR 50 can directly email or fax the contents to one or more destinations (email address or fax number) specified by the user. A block diagram of the APR 50 is presented in FIG. 5. APR 50 comprises a microcontroller 500 that manages the different components of said printer, such as, but not limited to:
a conventional printer 500 to print on conventional paper,
a contactless reader 505 to recognize the AP (i.e. read its identification tag) that has been placed inside the printer 50 (if said printer is adapted to physically receive an AP) or next to it (within the communication range of reader 505). NFC technology may be used to that matter, and,
a wireless network interface 510 to receive via network 25 the contents of AP. The transfer may also be direct from the AP to the augmented printer, using NCF technology, and the likes. The transfer may be triggered once AP 20 has been identified by the APR 50.

The document management system according to the present system may also comprise an Augmented Recycle Bin (ARB) 60 as seen in FIG. 1. ARB 60 may be a conventional paper recycle bin enhanced with different electronic components as depicted in FIG. 6, such as a microcontroller 600 (or processor) as the main computational unit of the augmented recycle bin 60, that manages the different components of said bin, such as, but not limited to:
a contactless reader 605 to recognize the AP (i.e. read its identification tag) that has been placed inside ARB 60, and,
a wireless network interface 610 to notify via network 25 the document management server 15 that the AP content has been recycled. The notification is triggered once AP 20 has been identified by recycle bin 60. Server 15 may update the record of the data file corresponding to the AP content. The contents of AP are also emptied during this procedure.

An Augmented Shredder (ASH) 70 may also be provided in the document management system according to the present system. Such a shredder 70 may be a conventional paper shredder enhanced with the electronic components depicted in FIG. 7. This shredder does not destroy the AP as a conventional shredder would destroy paper sheets inserted into it. It just securely deletes the electronic contents of AP 20 when placed inside said shredder, and the electronic copies of contents stored on repository 10. AP may receive the empty instruction directly from the augmented shredder or through the DMS.

As seen in FIG. 7, ASH 70 may comprise a microcontroller 700 as the main computational that manages the different components of the shredder, such as, but not limited to:
a contactless reader 705 to recognize the AP (i.e. read its identification tag) that has been placed inside shredder 70, and,
a wireless network interface 710 to notify via network 25 the document management server 15 that the AP content has been shredded. The notification is triggered once AP 20 has been identified by shredder 70. Server 15 then erases all electronic copies of the AP content on repository 10. AP is also emptied of its contents. AP may receive the delete instruction directly from the augmented shredder or through the DMS.

It might be observed that the electronic components of the recycle bin and the shredder are identical. As a result, the same electronics circuit could be used to achieve the functionality of either of these equipments, with slight modifications to their software and/or firmware.

Other components of the document management system according to the present system may include an Augmented Tray (AT) 80 as seen in FIG. 1. This tray 80 is similar to a conventional paper tray in form and structure. But, it may be enhanced with electrical contacts for recharging augmented papers and folders (when comprising an active tag 310) when placed inside said tray, with contacts provided on AP and AF coming into contact with the augmented tray contacts.

It is important to note that many additional components may be added to the system as long as they implement appropriate communication protocols. For instance, a digital camera can directly “print” to a nearby AP or an AP can directly display its contents on a nearby wall display provided these external components support the right communication technologies and application protocols.

One feature of the system according to the present system using the different components listed here before in conjunction with the APs 20 resides in its physicality. Many known document management systems have failed so far because the tangible aspect of paper is lost. With the augmented papers and the different components, a user will carry on handling an electronic document the way he/she was handing a paper document when scanning, printing, throwing away, classifying, . . .

The different components described in relation to FIG. 4 to 7 are exemplary components that contribute to maintaining the physical aspect of the document management system. Other components for receiving an AP are within the scope of the present system, and may comprise:
a reader, like an NFC reader, for reading an identifier of the AP when the AP is received by the apparatus. An authentication is then performed by the apparatus using the AP identifier,
a communication interface adapted to cooperate with the AP communication interface, for exchanging electronic documents with the AP, once the AP has been authenticated.

By “received”, one may understand that the AP is placed nearby the component (i.e. within its range of detection) of the document management system, as a contactless detection may also be used.

Furthermore, the apparatus is adapted to send a log message to the DMS (using its communication interface), the log message comprising information about the electronic documents exchanged between the apparatus and the AP.

The document management system according to the present system offers many different functionalities, such as, but not limited to:
User registration
Reading and writing AP documents
Filing electronic documents
Sharing AP documents
Transferring contents between conventional and augmented papers
Reusing augmented papers
Seamless access
System administration

Each of these functions is described in detail hereafter.

A user may register himself with an AP 20. The registration process is used to give a meaningful name to AP, and to specify login credentials and system preferences. The information collected from the registration process may be stored on the fixed non-volatile storage 230 (as seen in FIG. 2). This information may also be transferred to the document management system 15 through wireless interface 215.

When a user specifies his login credentials (e.g. user-id/password or cryptographic keys or biometric ID) to the AP 20, said AP may use these credentials to access the repository 10.

These credentials could also be used to protect the contents of AP. If a login is specified, the content can be accessed only upon a successful login.

A user may also specify one or more of the following optional settings of the document management system according to the present system:

MAX_IDLE_CONNECTION_DURATION—The maximum duration for which the AP will remain connected to the document management server when the AP is idle. An AP can determine whether it is being currently used by reading its temperature and motion sensors 220 as seen in FIG. 2. If temperature sensor 220 reads a low AP temperature and/or motion sensor 220 senses no motion, it is highly likely that AP 20 not being used. Furthermore, microcontroller 235 may maintain an idle timer. This timer is reset if either of the sensors fires and/or user initiates an action (such as scrolling, opening, saving, etc). If the timer is not reset for more than this MAX_IDLE_CONNECTION_DURATION, AP 20 goes to sleep mode. When an AP is asleep, display 205 will be blanked out. In an additional embodiment of the system according to the present system, it may only display the AP's name and/or its owner's name,

AUTO_ATTACH—This parameter specifies whether the AP can connect to other components automatically or the user must initiate the connection procedure. As described above, the connection is established through the auto identification devices such as RFID and NFC. The connection can be initiated by either the AP or the other components,

DISPLAY_SHARE—This parameter specifies whether an AP can display contents of other augmented papers. If set, its screen can be used by other augmented papers, when for example said AP is placed in the vicinity of the other augmented papers,

CONTENT_SHARE—This parameter specifies whether the content of a first AP can be displayed on a second AP, if they are in each other's vicinity. If set, the contents of the first AP can be displayed on the screen of the second AP. This mechanism enables users to acquire more screen space by adding more AP. For instance, the user could simultaneously view different sections of the same electronic document on by placing multiple APs side by side. The content sharing procedure is described in detail below in relation to FIG. 15.

This parameter may be fine tuned using the following flags:
PRIVATE_SHARE—If this parameter is set, the content will be displayed on other augmented papers belonging to the same owner.
PUBLIC_SHARE—If this parameter is set, the contents will be displayed on any AP (including the ones that do not belong to the same user).

AUTO_BACKUP—This parameter specifies whether the contents of this AP can be automatically backed up on the document management server. By default, this parameter is set. However, when a user is working on a private document for instance, he/she may disable the automatic back-up behavior,

CONTENT_REPLACEMENT_POLICY—several electronic documents may be stored in AP 20 for display. This parameter specifies the policy to use when swapping out the contents of the AP to make room for new contents. The options may be:
First In First Out—The oldest document on the AP will be swapped out,
Least Recently Used—The document with the lowest last access time will be swapped out,
Least Frequently Used—The document that was used least in the last ‘n’ days will be swapped out, where the number n can chosen as required.

It is interesting to note that any appropriate page replacement algorithm used by conventional operating systems can be employed for replacing the contents.

An AP in the document management system according to the present system allows the users to conveniently read, write and annotate documents. Additional functionalities are described here after to support such actions from the user.

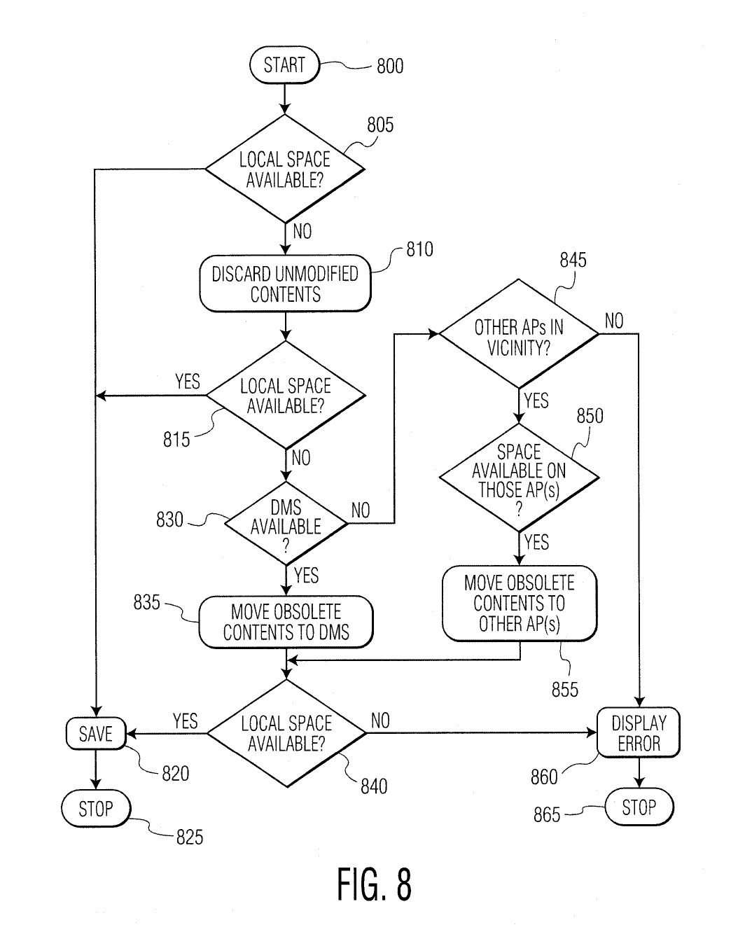

To reduce their cost and dimensions, augmented papers may be built with small non-volatile storage. However, in order to avoid shortage of storage capacity in an AP, the document management system according to the present system is provided with a functionality that may be described as an extended storage. When the AP non-volatile storage runs out of space, AP will attempt to find free storage space using the following acts, described with respect to FIG. 8.

In a first act 800, the user initiates the save procedure (e.g. he/she hits a save key) when she wants, for instance, to save a modified electronic document. The AP microcontroller then initiates a search for free storage space.

In a subsequent act 805, AP microcontroller checks if storage space is available locally, e.g. on the local non-volatile storage, or any additional AP storage space, like a removable non-volatile storage. If local space can be found, in a subsequent act 820, the electronic document is saved on said local storage. The search can end in last act 825.

If no local storage can be found, in an alternate act 810, AP microcontroller will discard electronic documents that were downloaded from the document management server and left unchanged, or that were not modified since last connection to (and last saving on) the document management server. AP microcontroller then checks if enough space could be freed from act 810 in a subsequent act 815. If so, the save sequence resumes with act 820.

If not, in an additional act 830, AP microcontroller will check if a document management server (DMS) can be reached. If it is, AP microcontroller will transfer some of the electronic documents (that may be chosen, as explained above, using the CONTENT_REPLACEMENT_POLICY) on the local storage to the server to free local space in a further act 835. After a further act 840 wherein the microcontroller verifies if local space is available, the save sequence resumes with act 820. If for some reasons act 835 did not lead to enough free space (moved electronic documents did not free enough space for instance), an error message will inform the user in a subsequent act 860, and the save sequence will stop in an act 865.

If DMS is not available as checked in act 830, microcontroller verifies if any other augmented papers are in the vicinity in an additional act 840. If there are other APs and they have free space (checked in act 850), it will move some local contents (act 855) to them. It will throw an error message to the user in an act 860 in the event no local or no remote storage space can be found.

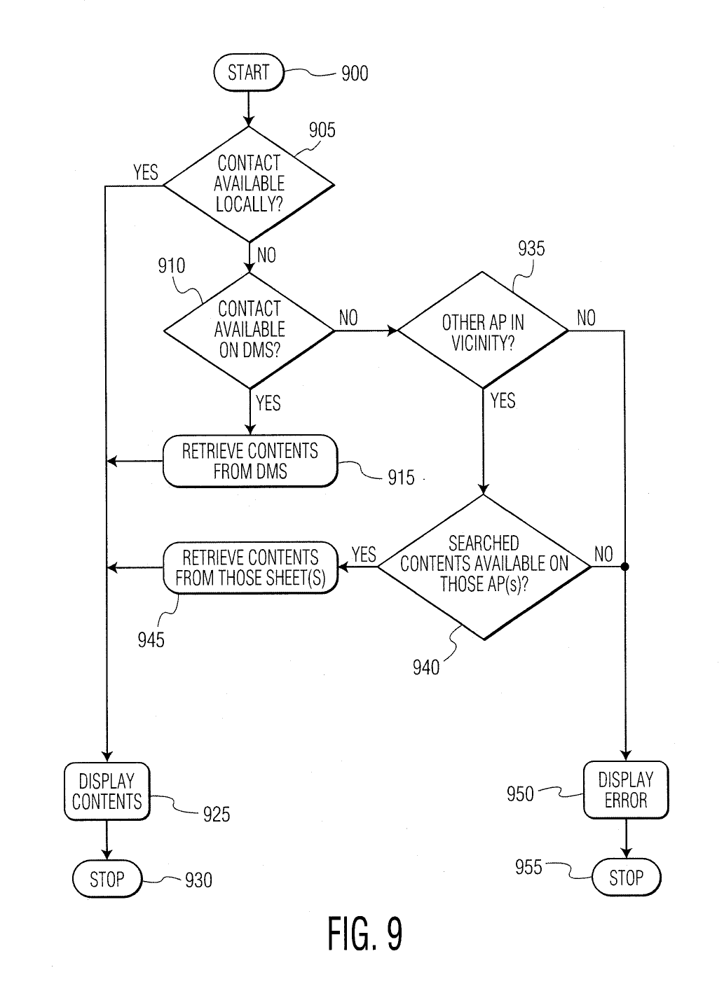

In the document management system according to the present system, a content navigation and search tool is also provided so as to allow any users to find electronic documents on all storage media (local and remote, as explained above) available to them. This content search tool works as depicted in FIG. 9.

After initiation of the search for specific content by the user (in a first act 900), first, the local storage of the AP at hand (i.e. a first AP) will be searched. If the content is found, in a further act 925, said content is displayed and the search is terminated in act 930. If the content is not found locally, AP will connect to the document management server in a further act 910 and look for said content on the repository. If the DMS is reachable, and the content is found on the repository, it is retrieved through the document management server and displayed in the subsequent act 925.

If the content is not available on document management server, as checked in act 910, the AP will check if other augmented papers are in the vicinity in act 935, and if so, their storage will be searched in a further act 940. The other APs may be identified using a local network based e.g. on NCF technology. If the searched content is available on one of the neighboring augmented papers, it is retrieved in act 945 for further display in act 925. If the searched content is not found, an error message is displayed to the user in an alternate act 950 and the search is stopped in act 955.

The search may be performed in a different order, e.g. starting with the repository or the neighboring APs. In any event, the specific content is transmitted to the AP at hand when retrieved elsewhere from said AP, using the relevant network.

The AP of the document management system according to the present system may be further enhanced with browsing functionalities, to browse the content of neighboring augmented papers as well as the electronic documents stored in repository 10 of FIG. 1. The repository as well as the storage medium of an AP may be organized in a tree like manner for an easier browsing of the content.

One of the major benefits of conventional paper documents is that a user can view many of them simultaneously and spread them around in physical space. The same effect is achieved using the augmented papers of the document management system according to the present system: if there are multiple augmented papers in the vicinity, their displays can be used collectively to provide a large aggregate display to the user. For instance, if a user is working on document that has multiple pages and he/she needs to refer to several pages simultaneously, he/she can use multiple augmented papers each displaying a different page of the document.

The augmented papers of the system according to the present system provide an easy sharing: to transfer the contents to a different display, the user has to press two displays against each other, or keep them within the communication ranges of NFC readers (so that they can read the tags on the other) of APs, and press the “MOVE” button on the source and “ACCEPT” on the destination display. In an alternative embodiment of the easy sharing method according to the present system, the transfer may be automatically carried out upon detection by a first AP (with the content to be shared) of neighboring APs. This may be achieved through periodic detection by a first AP of any neighboring APs.

The sharing of content may be carried out as follows, in relation to FIG. 15. In a first act 1500, a transfer of the content of a first AP is triggered (for one of the reasons listed here above). The act 1505 may be carried out to check whether the content to be shared is private or not. The CONTENT_SHARE parameter mentioned before specifies whether the content of the first AP can be shared and displayed on other APs. If the content is private, the transfer may be stopped right away in act 1530.

If the content is not private (or if there is no act 1505), in a further act 1510, the first AP searches for other neighboring APs using its contactless reader, used as a sensing element. Other APs placed in the vicinity of said first portable display are identified through their identification tag.

If the first AP does not find any other AP (act 1515), the transfer may be stopped right away in act 1530. If at least one other AP is found (act 1515), the DISPLAY_SHARE parameter of the second AP is checked (in act 1520). If the second AP cannot display contents of other APs, the transfer will be stopped right away in act 1530.

In a subsequent act 1525, the content of the first AP is transferred to the identified second APs and gets displayed on that device. The transfer, using a communication interface such as wireless transceiver 210, may be direct using e.g. NFC technology, or indirect through the DMS. In the case of a direct transfer, the transfer may use the communication interfaces of the APs. The man skilled in the art will understand that the transfer may be contactless, or when the communication interfaces come into contact with each other. The user may have to press an ACCEPT key on the second AP to finish the transfer. In an alternative embodiment, the transfer and display may be automatic once at least one second AP has been detected.

An AP in the document management system according to the present system may be further enhanced with a freeform stylus-based application that can be used to sketch, write and annotate any electronic document displayed on said AP. This tool also provides conventional text editing and drawing tools and libraries to facilitate these tasks. The modified electronic document may be then saved by the user, either on the AP local storage (if space is available), or on the repository, or on any neighboring AP, for instance based on the extended storage as described in relation to FIG. 8. Thus the new version of the AP electronic document is updated in the system according to the present system.

The proposed system also provides an automatic filing mechanism both in the physical and digital realms. The processes involved in the automatic filing processes are:
Naming Folders
Organizing Augmented Papers and Folders

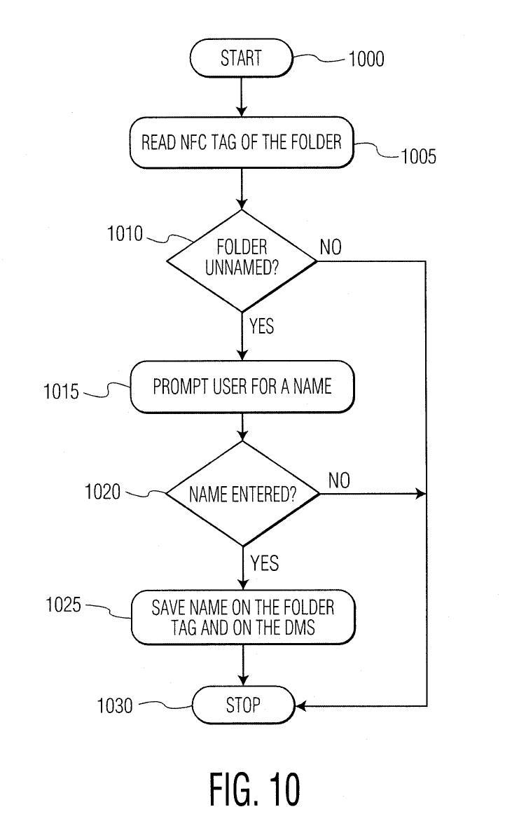

The augmented folders can be named for convenience. They may come with a default name for the system according to the present system that the user may change. The user defined name can be any valid name such “tax documents”, “mortgage papers”, etc. The naming of folder is described in relation to FIG. 10. When the user places an AP in an augment folder in a first act 1000, the AP reads the folder's identification tag (act 1005) and further checks in act 1010 if the AF is unnamed. If so, the AP will prompt the user in an additional act 1015 to require for the user to enter an AF name. Once the name is entered (act 1020), he/she may save the name on the folder tag (act 1025). The AF representation on the repository of the system according to the present system may also be renamed subsequently with the same name entered by the user in act 1025. For instance, when the user presses the “SAVE” button, AP would save the name on the AF identification tag and send a message to DMS with the Tag ID (identification) and user specified name so that repository 10 is updated accordingly. This way the user can access folders using convenient names instead of hard-to-read numeric identifiers.

The naming is finished with act 1030. If no name is entered (act 1020) or the folder has been named already, the naming will end automatically.

The user may also rename an augmented folder by using an AP. The renaming is similar to the naming explained above. However, act 1010 is different as the AP prompts for a new name.

The users can file augmented papers in physical and digital realms by placing them inside augmented folders in the document management system according to the present system. When an AP is placed inside an augmented folder, it will read the identification tag and sense that it has been placed inside an augmented folder. The AP can also determine the ID and name of the folder from that tag. It will note down the folder as its “parent” and it will also notify the document management server about its parent folder.

If the document is not present yet on the repository (new electronic document resulting from a scan of a paper document for instance, or a modified document), the electronic document will be automatically transferred via the wireless network 25 to the DMS. After the transfer, or when the electronic document is already available in the repository, DMS will store it in the AF representation in the hierarchy of the repository. For instance, if an AP that contains lyrics of Elvis Presley's songs were placed inside the folder “Elvis Discography”, the paper would send a message to DMS with its ID and the ID of “Elvis Discography” folder to DMS. The DMS in turn would place the AP under the “Elvis Discography” file folder on its storage.

The AP also retains the information about its parent so that if it were placed in the same folder again, it would not do anything since the filing action is just a repetition. It is important to note that this system supports nested folders: if an augmented folder is equipped with a reader, it can read its “parent” folder so that a file hierarchy can be constructed. Consider the “Elvis Discography” folder again. If it were equipped with a reader and were placed in the folder “Elvis Presley”, the system would construct the filing structure (top-down): “Elvis Presley”->“Elvis Discography”->“Elvis Lyrics”. This chain can be extended to any number of containment levels.

The filing method is further described in relation to FIG. 16 described here after. In an initial act 1600, an AP comprising electronic documents is placed into an augmented folder AF. The placing of an AP in the augmented folder will initiate the following acts:

AP senses the AF tag in a subsequent act 1605 and read it in act 1610, using the contactless reader 225 (as seen in FIG. 2). Contactless reader 225 is used as a sensing element to detect the insertion of the AP in the folder upon sensing the AF tag. In a further act 1615, the system according to the present system may check whether the AF has been named before. If not, in a following act 1620, the naming of the AF may be carried out. The user can enter the necessary information through the soft keypad of the AP, or using a stylus on said AP. The name may also be provided through a keyboard operatively connected to the document management server. Other naming procedures are readily understandable to a person skilled in the art.

In a further act 1625, insertion information is sent to the DMS. This information may comprise the augmented folder identifier or ID, as read from the AF tag, the folder name (if named in act 1620) and the AP identifier. Using these details, the document management server creates a digital representation of the AF (if it does not exist yet) in repository 10 using the folder ID and/or name, and link the electronic documents stored in the AP to said digital representation. To do so, the DMS will use the transmitted AP ID to retrieve the AP content information and link said content to the digital representation of the AF. As mentioned earlier, a transfer of the electronic documents to DMS may also occur from the insertion of the AP into the AF, if the AP content is not available on DMS yet.

The filing method according to the present system ends in a further act 1630.

The users may also share the contents of augmented papers using one of the following two mechanisms:
Indirect sharing through the DMS
Direct Paper-to-Paper sharing

Both these mechanisms are described next.

Indirect sharing is achieved by publishing the contents available on the DMS. To make sure there is no unauthorized access or sharing, each document may have following access rights.

With regards to network publishing, users can share the contents stored on the DMS. However, to do so, the user must have the necessary access privileges.

Regarding Paper-to-Paper Copying, It is also possible to transfer contents from an AP to another without involving the DMS. A direct transfer can be achieved by bringing together two APs or touching one AP with another and initiating the transfer process over a wireless interface (using Bluetooth technology for example). In both the cases the sender and receiver can be authenticated to ensure data security. This paper-to-paper copying can work in a broadcast mode, where multiple augmented papers can simultaneously receive contents from a single AP. This broadcast approach could be useful in situations where multiple parties need to access same content. For instance, in conferences and meetings speakers might need to disseminate their presentation to other audience.

Since all technical advances take time for adoption and widespread use, backwards compatibility is an important requirement for novel technologies. The proposed system provides tools and mechanisms for seamlessly migrating from conventional papers to augmented ones.

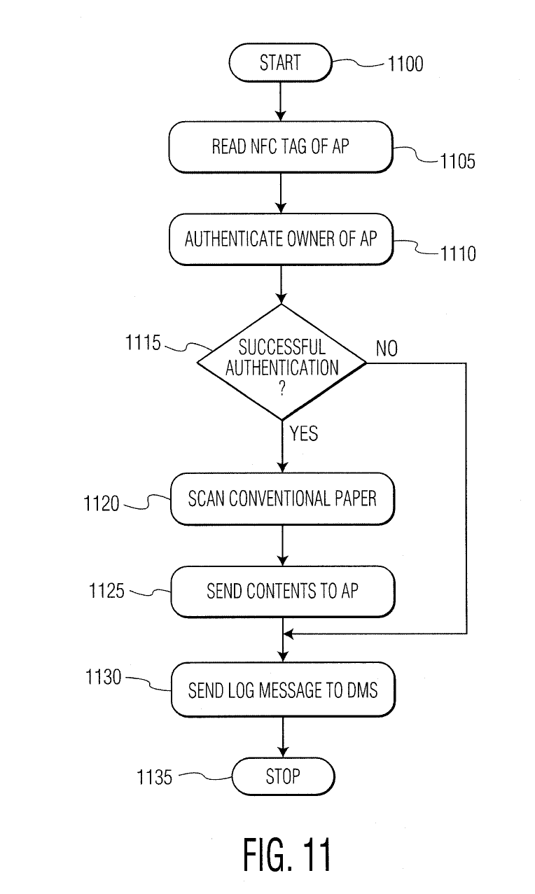

To copy (i.e. convert) conventional paper content to an augmented paper for display, the augmented scanner defined before in relation to FIG. 4 may be used according to the flow chart of FIG. 11 and described here after.

When an AP is placed in the output tray of an Augmented Scanner in act 1100, the augmented scanner reads the identification tag of that AP and sends a session initiation request to the AP (act 1105). In an optional authentication act 1110, if the scanner is an entity trusted by that AP, said AP shares the information about its owner with that scanner. The scanner in turn prompts the user (the person attempting to scan) for authentication. If the user is able to successfully authenticate (act 1115), or if no authentication is required, the scanner scans the conventional paper (act 1120) and sends its contents to the AP (1125) over a communication interface such as a wireless interface. The transmission may be direct (augmented scanner to AP using NCF technology, such as Bluetooth or the likes) or indirect (through the DMS, using WIFI or the likes). All transactions may be logged by the DMS (optional act 1130) to ensure data security and traceability. The conversion ends in act 1135.

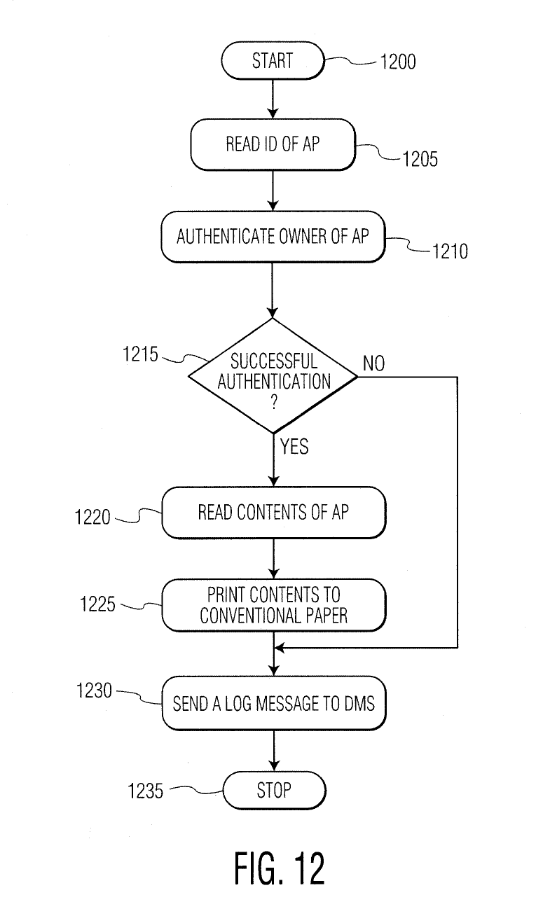

Conversely, the content of augmented papers can be easily printed onto conventional papers as well. This conversion process is illustrated in FIG. 12.

When an AP is placed in the input tray of an Augmented Printer (act 1200), the printer reads the identification tag of the AP and sends a session initiation request to that AP (act 1205). In an optional authentication act 1210, if the printer is an entity trusted by that AP, said AP shares the information about its owner with that printer. The printer in turn prompts the user (the person attempting to print) for authentication. If the user is able to successfully authenticate (act 1215), or if no authentication is required, the content of that AP is transferred to the augmented printer in a further act 1120, the transmission being either direct AP to printer or indirect using the network. In a subsequent act 1225, the content is printed on conventional papers. All transactions may be logged by the DMS (optional act 1230) to ensure data security and traceability. The conversion ends with act 1235.

In both instances of conversion, if the optional authentication act fails, the scanning and printing are respectively skipped and the failure is logged by the DMS (act 1130 and 1230 respectively).

The augmented papers can be recycled and reused as conventional papers can be used. An AP can be reused using recycling and shredding processes. The difference between these processes are listed below in Table 1:

TABLE 1
recycling/shredding differences

| | Recycling | Shredding |
|---|---|---|
| Contents | Only the contents | The contents on the AP and their |
| Deleted? | on the AP | copies on the network are |
| | | deleted. |
| Configuration | No | Yes, the AP is completely wiped |
| Deleted? | | and restored to its factor status. |
| Operation | Yes | No. There will be no trace in the |
| Logged? | | system about the contents or the |
| | | shredding operation. |

The shredding process can be used when sensitive documents must be destroyed without any trace and the recycling process can be used to reuse the augmented papers in a new project. Both these processes are described in detail below.

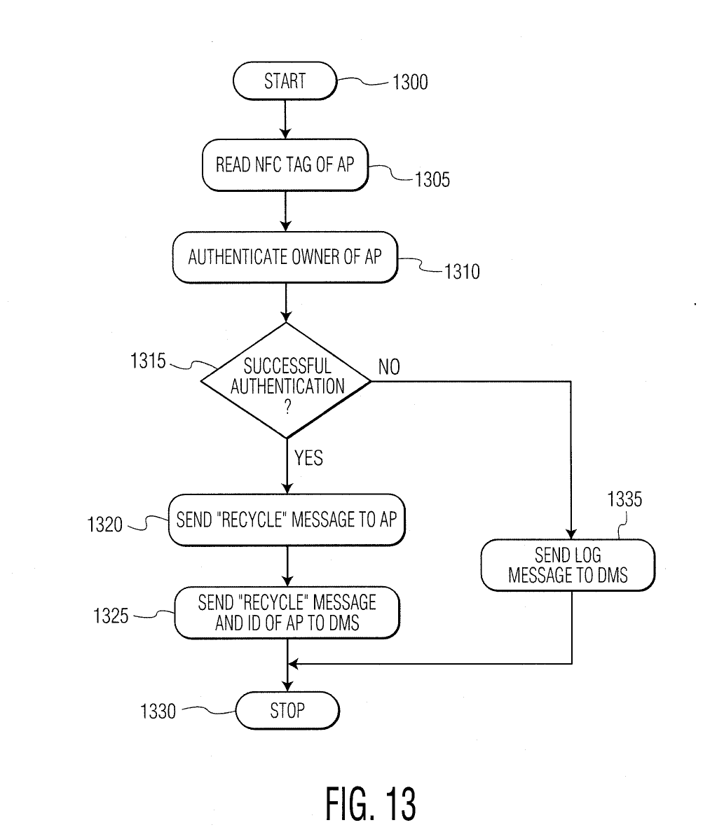

The recycling process is depicted in FIG. 13. When an AP is placed inside an Augmented Recycle Bin in an initial act 1300, the bin reads the identification tag of the AP, and sends a session initiation request to the AP in a subsequent act 1305. In an optional authentication procedure 1310, if the augmented recycle bin is an entity trusted by that AP, said AP shares the information about its owner with that bin. The bin in turn prompts the user (person who is attempting to recycle) for authentication. If the user is able to successfully authenticate (act 1315), or if no authentication is required, the bin sends a “RECYLE” message to that AP in act 1320. Upon receiving that message, the AP empties all its data contents except the configuration information such as user registration details. In a further act 1325, the bin also sends a message to the DMS that the AP has been recycled. This causes the DMS to log the AP content change and set the state of that AP to “recycled”. All transactions may be logged on DMS to ensure data security and traceability. The recycling ends in act 1330. If the authentication act fails in act 1315, the authentication failure is logged by the DMS in a subsequent act 1335 before ending the recycling process in act 1330.

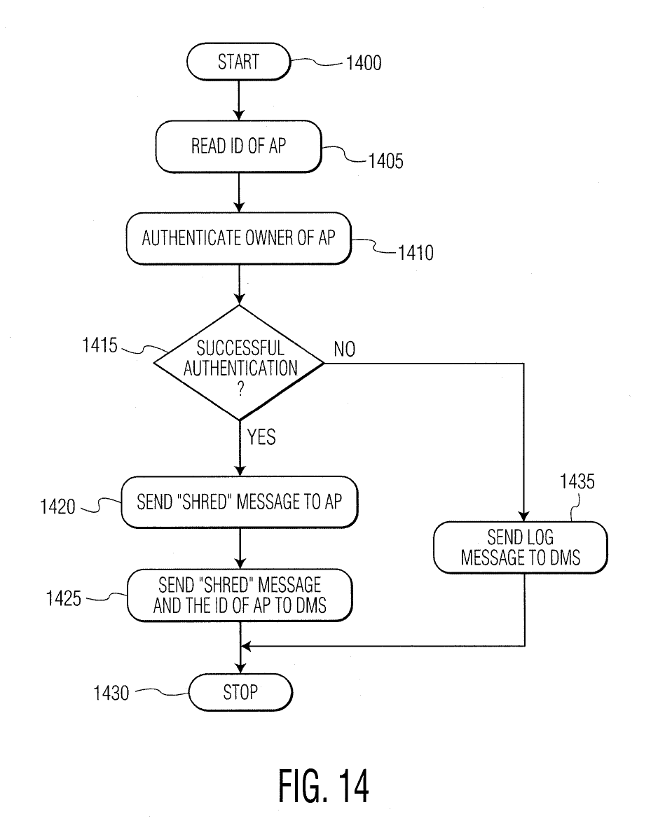

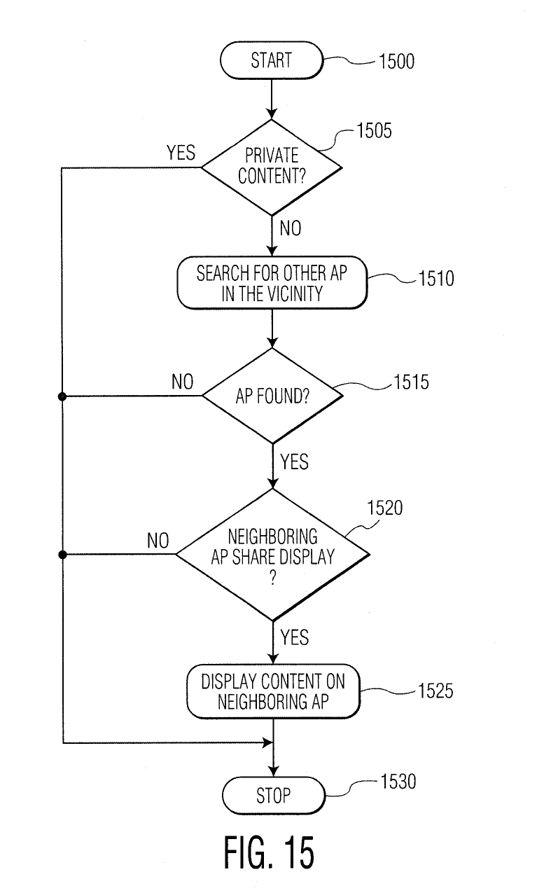

The shredding process is depicted in FIG. 14, and is very similar to the recycling process. When an AP is placed inside the Augmented Shredder in an initial act 1400, the shredder reads the identification tag of the AP, and sends a session initiation request to the AP in a subsequent act 1405. In an optional authentication act 1410, if the shredder is an entity trusted by that AP, said AP shares the information about its owner with that shredder. The shredder in turn prompts the user (person who is attempting to shred) for login credentials. If the user is able to successfully authenticate (act 1415), or if no authentication is required, the shredder sends a “SHRED” message to that AP in act 1420. Upon receiving that message, the AP empties all its data contents including, optionally, the configuration information such as user registration details. In a further act 1425, the shredder also sends a message to the DMS that the AP has been shredded. This causes the DMS to purge all data related to that AP contents from the repository. As the objective of shredding is to destroy all traces of data, the shredding transactions are not logged on DMS to eliminate any traceability. In an alternate embodiment, the shredding process acts like the recycling process with the exception that the shredding process also removes the content from the DMS in addition to removing it on the AP. The shredding ends in act 1430. If the authentication act fails in act 1415, the authentication failure is logged by the DMS in a subsequent act 1435 before ending the shredding process in act 1430.

In case a plurality of Document Management Servers are available, they are adapted to cooperate with each other so that the users can have a seamless access to the contents of their augmented papers and the respective repositories as they move from one access network to the other. The augmented papers depend on these servers for establishing identity and authentication of other devices. Moreover, these servers allow users to access, manage and publish all their contents in one point. These servers may offer collaborative editing tools such as wiki for publishing and sharing their documents.

The DMS may offer a system administration tool to configure and manage all components (AP, hardware equipment such as augmented shredder and software packages such as collaborative editing tools) of the system.

Finally, the above-discussion is intended to be merely illustrative of the present system and should not be construed as limiting the appended claims to any particular embodiment or group of embodiments. Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow. In addition, the section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts or steps is intended to be required unless specifically indicated; and

i) the term “plurality of” an element includes two or more of the claimed element, and does not imply any particular range of number of elements; that is, a plurality of elements may be as few as two elements, and may include an immeasurable number of elements.

1. An electronic document management system comprising:
a repository for storing electronic documents,
a portable display for displaying at least one electronic document stored in said portable display,
a folder adapted to receive the portable display,
wherein the repository comprises a digital representation of the folder, said system being arranged to link in said repository the at least one electronic document with said digital representation when the portable display is received in said folder.

2. The system of claim 1, wherein the repository is arranged to store the at least one electronic document in the digital representation when the portable display is received in the folder.

3. The system of claim 1, wherein the at least one electronic document is sent to the repository for storage in association with the representation of the portable folder.

4. The system of claim 1, wherein the portable display is an electronic paper display.

5. In an electronic document management system comprising:
a repository for storing electronic documents,
a portable display for displaying at least one electronic document stored in said portable display,
a folder adapted to receive the portable display,
a method for organizing electronic documents, said method comprising the acts of:
receiving insertion information from the portable display, said insertion information comprising information that said portable display has been inserted in a folder,
linking in the repository the at least one electronic document with a digital representation of the folder.

6. The method of claim 5, further comprising the act of storing the at least one electronic document in association with the digital representation.

7. The method of claim 5, the folder being characterized by a folder identifier, and wherein the insertion information comprises said folder identifier.

8. The method of claim 5, wherein the portable display is an electronic paper display.

9. An application embodied on a computer readable medium and arranged to manage electronic documents in an electronic document management system, said document management system comprising:
a repository for storing electronic documents,
a portable display for displaying at least one electronic document stored in said portable display,
a folder adapted to receive the portable display,
the application comprising:
a portion arranged to receive insertion information from the portable display, said insertion information comprising information that said portable display has been inserted in a folder,
a portion arranged to link in the repository the at least one electronic document with a digital representation of the portable folder.

10. The application of claim 9, the folder being characterized by a folder identifier, wherein the insertion information comprises said folder identifier.

11. A portable display for displaying at least one electronic document stored in said portable display, said portable display being operatively coupled to a document management server, and comprising:
a sensing element for detecting the insertion of the portable display in a folder adapted to receive said portable display,
a communication interface for sending insertion information to the document management server once the insertion is detected by the sensing element.

12. The portable display of claim 11, wherein the sensing element is adapted to read an identifier for the folder when said portable display is inserted in said folder, the insertion information comprising said folder identifier.

13. The portable display of claim 11, said portable display being operable to send the electronic document to the document management server once the insertion is detected by the sensing element.

14. The portable display of claim 11, wherein the sensing element is a tag reader adapted to read a tag carried by the portable folder.

15. The portable display of claim 11, wherein the portable display is an electronic paper display.

16. A document management system comprising:
a first portable display for displaying at least one electronic document,
a second portable display adapted to display the at least one electronic document,
wherein the first portable display comprises a sensing element to detect the second portable display when placed in the vicinity of said first portable display, said detection causing the transfer of the at least one electronic document from said first to said second portable display for a subsequent display on said second portable display.

17. The document management system of claim 16, wherein the transfer is contactless.

18. The document management system of claim 16, wherein each portable display comprises a communication interface, the transfer requiring that both communication interfaces come into contact with each other.

19. The document management system of claim 16, wherein the first and second portable displays are electronic paper displays.

20. The document management system of claim 16, wherein the sensing element is a tag reader, adapted to read a tag carried by the second portable display.

21. A method for sharing at least one electronic document stored on a first portable display with other portable displays, the method comprising for the first display the act of:
detecting at least a second portable display in the vicinity of the first portable display through a sensing element,
transferring the at least one electronic document to the second portable display for a subsequent display on said second portable display.

22. The method of claim 21, wherein the transferring act is contactless.

23. The method of claim 21, wherein each portable display comprises a communication interface, the method further comprising a preliminary act wherein the communication interface of the first portable display is put into contact with the communication interface of the second portable display, the transferring act being carried out thanks to said communication interfaces.

24. The document management system of claim 21, wherein the first and second portable displays are electronic paper displays.

25. The document management system of claim 21, wherein the sensing element is a tag reader, adapted to read a tag carried by the second portable display.

26. An application embodied on a computer readable medium and arranged to share at least one electronic document stored on a first portable display with other portable displays, the application comprising for the first display:
a portion to receive detection information from a sensing element, said detection information signaling that at least a second portable display is in the vicinity of the first portable display,
a portion to transfer the at least one electronic document to the second portable display for a subsequent display on said second portable display.

27. An application as in claim 26, wherein the detection information comprises the identifier of the second portable display.

28. A first portable display for displaying at least one electronic document, said first portable display comprising a sensing element to detect a second portable display when placed in the vicinity of said first portable display, said first portable display being arranged to transfer at least one electronic document from said first to said second portable display for a subsequent display on said second portable display.

29. The first portable display of claim 28, wherein the transfer is contactless.

30. The first portable display of claim 28, said first portable display comprising a communication interface, the transfer requiring that said communication interface comes into contact another communication interface comprised on the second portable display.

31. The first portable display of claim 28, said first portable display being an electronic paper display.

32. The first portable display of claim 28, wherein the sensing element is a tag reader, adapted to read a tag carried by the second portable display.

33. An apparatus for receiving a portable display capable of displaying an electronic document, said apparatus comprising:
a reader for reading an identifier of the portable display when received by said apparatus said apparatus being arranged to authenticate said portable display using said identifier,
a communication interface for the apparatus adapted to cooperate with a communication interface for the electronic document, for exchanging electronic documents with said portable display, once said portable display has been authenticated.

34. The apparatus of claim 33, further adapted to send a log message to an electronic document management server using said apparatus communication interface, said log message comprising information about the electronic documents exchanged between said apparatus and the portable display.

35. The apparatus of claim 33, said apparatus being arranged to receive an electronic document carried by the portable display through the communication interfaces once said portable display has been authenticated, and wherein the apparatus further comprises a printing interface for printing the received electronic document.

36. The apparatus of claim 33, further comprising a scanner interface for generating an electronic document from a paper document, said apparatus being arranged to transfer the generated electronic document to the portable display through the communication interfaces once said portable display has been authenticated.

37. A portable display capable of displaying an electronic document, said portable display being arranged to be received by an apparatus, said portable display further comprising:
a first communication interface for sending an authentication message to the apparatus when said portable display is received by said apparatus,
a second communication interface adapted to cooperate with a communication interface of the apparatus, for exchanging electronic documents with said portable display, once said portable display has been authenticated.

38. The portable display of claim 37, further adapted to send a log message to an electronic document management server using said portable display communication interface, said log message comprising information about the electronic documents exchanged between the apparatus and said portable display.
